(19) United States
(12) Patent Application Publication
(10) Pub. No.: US 2004/0261569 A1
(43) Pub. Date: Dec. 30, 2004

(54) Piezodynamic vibration damping system

(76) Inventors: Jack H. Jacobs, Glendale, AZ (US); Marc E. Meffe, Glendale, AZ (US); Richard A. Hightower, Peoria, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/608,174

(22) Filed: Jun. 26, 2003

(51) Int. Cl. F16F 15/10

(52) U.S. Cl. 74/574

(57) ABSTRACT

A vibration damping device and method for momentum control devices is provided. The vibration damping device includes a piezodynamic damping spacer and a tuning system. The piezodynamic damping spacer is coupled to a bearing in the momentum control device. The piezodynamic damping spacer is configured such that vibrations in the momentum control device are absorbed by piezodynamic damping spacer. The piezodynamic damping spacer converts these vibrations to electrical energy, where they can be dissipated by the tuning system. The tuning system provides the ability to tune the vibration damping device to most effectively absorb vibrations in specific frequency ranges. Thus, the vibration damping device is able to effectively reduce vibrations in the momentum control device.

### FIELD OF THE INVENTION

This invention generally relates to momentum control devices, and more specifically applies to vibration control in momentum control devices in spacecraft.

### BACKGROUND OF THE INVENTION

Various types of momentum control devices are commonly used to provide attitude control to spacecraft and other vehicles. These momentum control devices are used to provide a torque on the vehicle for attitude control and other purposes. Examples of momentum control devices include reaction wheels and control moment gyroscopes.

Reaction wheels are commonly used to provide attitude and momentum control for a variety of vehicles. Reaction wheels typically comprise a rotor, bearings and motor, with the reaction wheel coupled to the vehicle structure, generally called a reaction wheel assembly (RWA). The motor provides the ability to vary the wheel speed of the rotor. As the rotor speed is varied, a momentum exchange occurs and the motor provides a torque on the vehicle about the spin axis. In most applications, multiple reaction wheels are used in a reaction wheel array. The multiple reaction wheels in the array are arranged so that their spin axes span three dimensions for three axis control. Arranging the multiple reaction wheels in this way allows the array to apply torque to the vehicle along different axes, generally all three. Torque can be selectively applied to these axes to provide attitude control of the vehicle.

Similarly, control moment gyroscopes (CMGs) are commonly used to provide attitude and momentum control for a variety of vehicles, including spacecraft and satellites. Control moment gyroscopes normally comprise a rotor and a motor to spin the rotor about a rotor axis. The rotor is typically supported in an inner gimbal assembly and is rotated about a gimbal axis using a gimbal torque motor assembly that is attached to one end of the gyroscope. A sensor module assembly is attached to the other end of the gyroscope and is used to sense the rotational position of the inner gimbal assembly about the gimbal axis to provide for control of rotation. The control moment gyroscope is mounted within the vehicle along the axis in which it will induce a torque. During operation of the gyroscope, the rotor is spun by a motor about its rotor axis at a predetermined rate. In order to induce a torque on the spacecraft, the gimbal torque motor rotates the gimbal assembly and the spinning rotor about the gimbal axis. The rotor is of sufficient mass and is spinning at such a rate that any movement of the rotor out of its plane of rotation will induce a significant torque around an output axis that is both normal to the rotor axis and the gimbal axis. This torque is transferred to the vehicle, causing the vehicle to move in a controlled manner.

While traditional momentum control devices such as reaction wheels and control moment gyroscopes are generally effective, they also can generate undesirable disturbances in the vehicle. Many advanced systems are sensitive to vibrations and other disturbances. Excessive disturbances can introduce errors into the system and shorten the lifespan of systems. Vibrations and other disturbances are particularly problematic in space systems, such as satellites. Vibrations in satellites can introduce a variety of errors and dramatically reduce the accuracy of the satellite. In many satellites the vibrations caused by these momentum control devices can be unacceptable. For example, satellites that are required to accurately orient themselves at a precise attitude or point a payload precisely are particularly vulnerable to vibrations and other disturbances that introduce jitter.

Examples of disturbances that can be created by momentum control devices such as reaction wheels and CMGs include disturbances created by the motors used to drive the rotors. These disturbances are commonly caused by rotor imbalance forces, and imperfections in the motor commutation circuits, which result in unwanted cogging and ripple torques.

Several different approaches have been used to reduce the effects of vibrations and other disturbances. These approaches include the use of passive devices, such as tuned-mass dampers and vibration isolators. Additionally, some active devices have been employed, such as electromechanically actuated struts, to attenuate or cancel these disturbances. Unfortunately, these past solutions have had several limitations. For example, passive devices typically eliminate only part of the disturbance. Past active devices, while generally being more effective have also generally had excessive power consumption and excessive weight, and have been computationally demanding.

Thus, what is needed is an improved system and method that reduces the impacts of disturbances with out requiring excessive weight, computation and power consumption.

### BRIEF SUMMARY OF THE INVENTION

The present invention provides a vibration damping device and method for momentum control devices. The vibration damping device includes a piezodynamic damping spacer and a tuning system. The piezodynamic damping spacer is coupled to a bearing in the momentum control device. The piezodynamic damping spacer is configured such that vibrations in the momentum control device are absorbed by piezodynamic damping spacer. The piezodynamic damping spacer converts these vibrations to electrical energy, where they can be dissipated by the tuning system. The tuning system provides the ability to tune the vibration damping device to more effectively absorb vibrations in specific frequency ranges. Thus, the vibration damping device is able to effectively reduce vibrations in the momentum control device.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of a vibration damping device;

FIG. 2 is a cross-sectional schematic view of a reaction wheel assembly;

FIG. 3 is a cross-sectional view of a momentum control device bearing with piezodynamic damping spacer;

FIG. 4 is a perspective view of a piezodynamic damping spacer;

FIG. 5 is a cross-sectional view of a momentum control device bearing coupled to a bearing piezodynamic damping spacer;

FIG. 6 is a schematic view of a tuning system; and

FIG. 7 is a schematic view of a sensor circuit.

### DETAILED DESCRIPTION OF THE INVENTION

The present invention provides a vibration damping device and method for momentum control devices. The vibration damping device includes a piezodynamic damping spacer and a tuning system. The piezodynamic damping spacer is coupled to bearing in the momentum control device. The piezodynamic damping spacer is configured such that vibrations in the momentum control device are absorbed by piezodynamic damping spacer. The piezodynamic damping spacer converts these vibrations to electrical energy, where they can be dissipated by the tuning system. The tuning system provides the ability to tune the vibration damping device to most effectively absorb vibrations in specific frequency ranges. Thus, the vibration damping device is able to effectively reduce vibrations in the momentum control device.

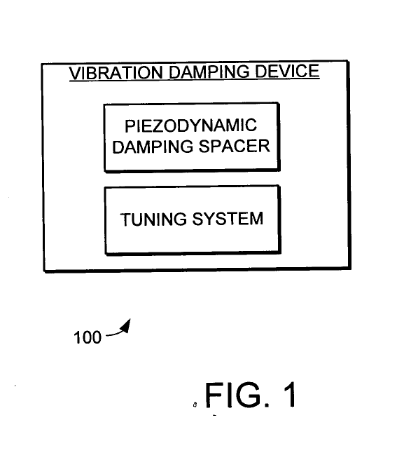

Turning now to FIG. 1, a schematic view of a vibration damping device 100 is illustrated. The vibration damping device 100 can be used to absorb vibration in momentum control devices such as reaction wheel assemblies (RWAs) and control moment gyroscopes (CMGs). The vibration damping device 100 includes a piezodynamic damping spacer and a tuning system. The piezodynamic damping spacer is coupled to at least one bearing in the momentum control device, configured such disturbances in the momentum control device can be absorbed by the spacer. The piezodynamic damping spacer converts the absorbed vibrations into electrical energy. The electrical energy created by the piezodynamic damping spacer is dissipated into the tuning circuit through heat. Thus, the vibration damping device is able to reduced vibration in the momentum control device and hence to the structure it is mounted upon.

The turning system additionally provides the ability to tune the resonant frequency of the vibration damping device 100. Thus, the tuning system provides the ability to optimize the frequency of the vibrations absorbed by the piezodynamic damping spacer. The tuning system preferably adjusts the resonant frequency of the vibration damping device to best absorb disturbances in selected problem frequency ranges. In one embodiment, the tuning system receives speed data from the momentum control device and uses this speed data to determine the resonant frequency of the vibration damping device 100. This allows the vibration damping device 100 to effectively absorb vibrations related to the operational speed of the momentum control device. For example, the vibration damping device 100 can be tuned to absorb speed related vibrations such as tachometer ripple, cogging, and other high frequency disturbances. It should be noted that while FIG. 1 illustrates the tuning system and the piezodynamic damping spacer together, in fact these two elements of the vibration damping device can be implemented in completely separate locations.

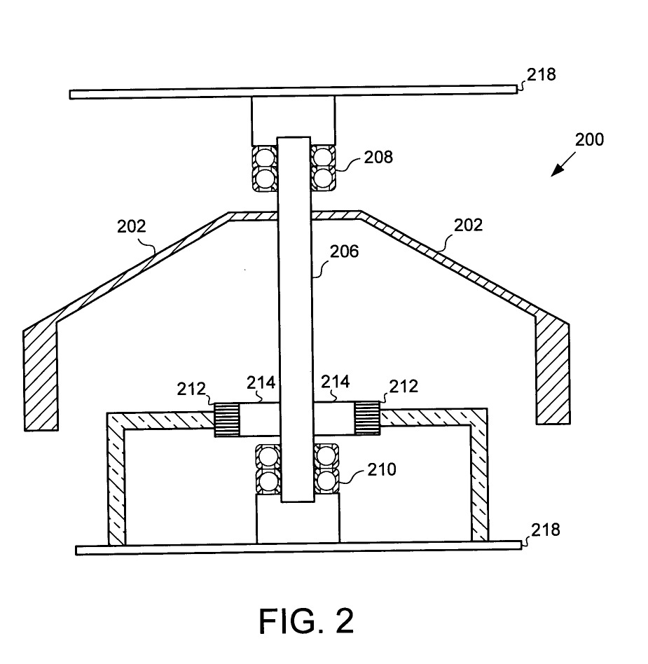

Turning now to FIG. 2, a cross-sectional view of a reaction wheel assembly 200 is illustrated. Reaction wheel assembly 200 illustrates one type of momentum control device in which the vibration absorbing device can be utilized. Other applications of the vibration absorbing device include other momentum control devices, such as control moment gyroscopes.

The reaction wheel assembly includes a rotor 202 coupled to a shaft 206. The shaft 206 rotates on bearings 208 and 210, and is driven by a motor that comprises a motor stator 212 and a motor rotor 214. The motor stator 212 is attached to a reaction wheel structure 216, which is attached to the vehicle through a base 218.

In operation, the motor stator 212 and motor rotor 214 rotates the shaft 206, causing the rotor 202 to rotate and impart a torque on the vehicle through the reaction wheel structure 216 and base 218. It should be noted that the reaction wheel assembly 200 is just one example of the type of reaction wheel assembly in which the vibration damping device can be implemented. Many other reaction wheels may be suitable for modification. For example, of suitable reaction wheels include the HR0610 and HR14 available from Honeywell International, Inc. Other examples of reaction wheel designs can be found at U.S. Pat. No. 5,873,285 issued to Bames and assigned to Honeywell International, Inc.

As stated above, the reaction wheel shaft 205 and rotor 202 rotate on bearings 208 and 210. Because the rotor 202 must reliably spin at high rates of rotation for very long periods of time, the bearings 208 and 210 are preferably high performance, precision bearings. In the example of reaction wheel 200, the bearings 208 and 210 are duplex bearings, meaning each bearing comprises a set of two bearings adjacent to each other. Other reaction wheel designs and other momentum control devices may use single sets of bearings. In either case, the vibration damping device can be used to absorb vibrations in the bearings to improve performance of the bearings and the overall device. Additionally, the vibration damping device can be used for other types of bearings in momentum control devices, including single bearings or so called “simplex” bearings.

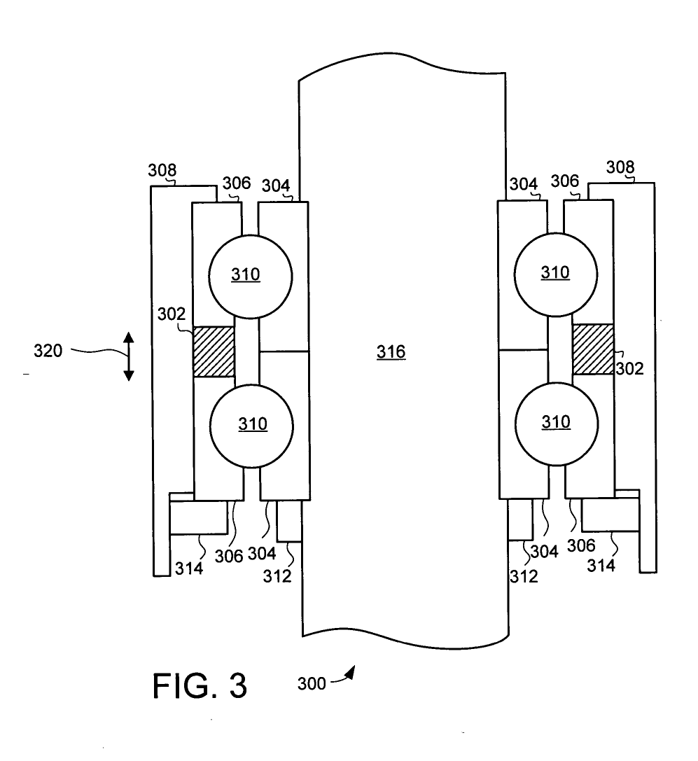

Turning now to FIG. 3, cross-sectional view of an exemplary bearing 300 that includes a piezodynamic damping spacer 302 is illustrated. Bearing 300 comprises a duplex bearing, meaning that two bearings are used together. Again, this is just one type of bearing that can be used in a momentum control device. Bearing 300 rotates about a shaft 316 and includes inner races 304, outer races 306, a bearing cartridge 308, balls 310, a shaft nut 312, and a preload nut 314.

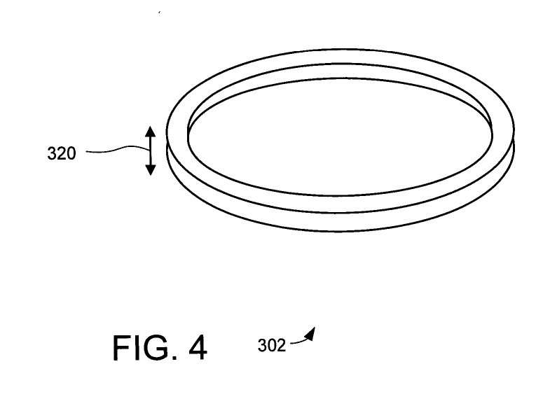

The bearing 300 is coupled to the piezodynamic damping spacer 302 in a way that allows the piezodynamic damping spacer 302 to absorb vibrations in the bearing 300. In the illustrated example, the piezodynamic damping spacer 302 comprises a ring that encircles the outer portion of the bearings. Turning briefly to FIG. 4, a perspective view of the complete piezodynamic damping spacer 302 is illustrated. The piezodynamic damping spacer 302 is configured as a ring or torroid. Vibrations in the bearings are absorbed by the piezodynamic damping spacer 302, causing the thickness of the spacer 302 to change, as illustrated by direction line 320. Of course, this is just one possible configuration for the piezodynamic damping spacer 302. Other potentially suitable shapes include partial torroids that may ease integration in particular applications

Returning again to FIG. 3, in the illustrated example the piezodynamic damping spacer 302 is located between the outer races 306. This is just one way in which the piezodynamic damping spacer 302 can be coupled to the bearings. For example, it can be coupled to the bearings though an intermediate member, such that vibrations in the bearings are transferred through the intermediate member, to the damping spacer. Also, instead of being between a duplex pair of bearings, the preload spacer could be configured at the edge of one or more bearings.

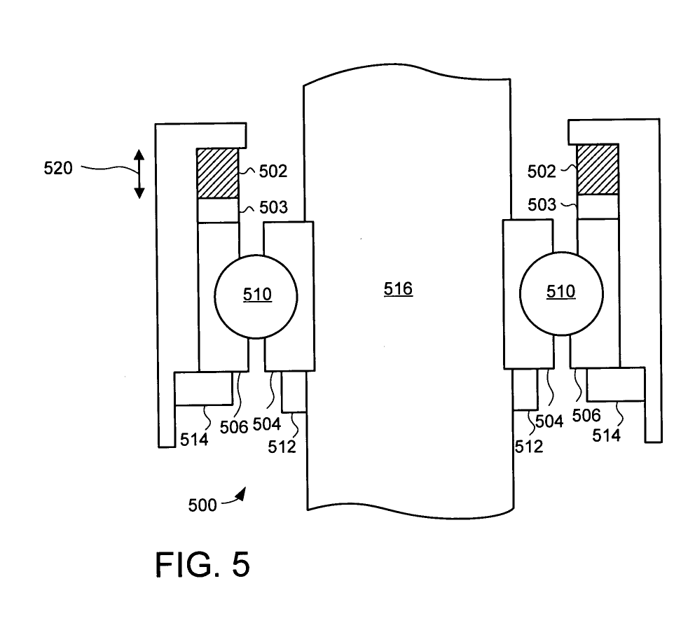

Turning now to FIG. 5, cross-sectional view of an exemplary single bearing 500 that includes a piezodynamic damping spacer 502 coupled through an intermediate member is illustrated. Again, this is just another type of bearing that can be used in a momentum control device. Bearing 500 rotates about a shaft 516 and includes an inner race 504, outer race 506, a bearing cartridge 508, balls 510, a shaft nut 512, and a preload nut 514. The bearing 500 is coupled to the piezodynamic damping spacer 502 in a way that disturbances in the bearing are absorbed by the spacer and converted into electrical energy.

In this illustrated example, the piezodynamic preload spacer 502 is coupled to the bearing 500 through an intermediate member 503. The piezodynamic preload spacer 502 can expand and contract in thickness, in the direction illustrated by line 508. Expanding and contracting in this way provides the ability to absorb vibration in the bearing, through the intermediate member 503.

The piezodynamic damping spacer can be made from any suitable piezodynamic material or combination of electro-mechanically coupled materials. As used in this specification, piezodynamic materials are those materials such as piezoelectric or electrostrictive materials that create or absorb electrical energy when mechanically deformed. These can take the form of single crystal layers or multi-layered stacks. Several types of piezodynamic materials are available commercially that could be applied to this application such as PZT, PMN, PLZT, etc. Each material formulation can either be layered into stacks to obtain a spacer structure with either polymer binder or a co-firing process for additional strength using existing manufacturing processes.

The piezodynamic damping spacer is configured such that absorbed vibrations are converted to electrical energy. This configuration can-include the polling of piezodynamic materials. For example, the piezodynamic material can be polled in a primary configuration, where mechanical deformation in a first dimension creates an electric field in a third dimension. As another example, the piezodynamic material call be polled in secondary configuration, where mechanical deformation of the in the first dimension creates an electrical field in the first dimension. In either case, the piezodynamic damping spacer would be coupled to the bearing and electrically connected such that vibrations from the bearing can be absorbed by the spacer and dissipated through the tuning system.

As stated above, the piezodynamic damping spacer can be coupled to the bearings in a variety of ways. As illustrated in FIG. 3, the piezodynamic damping spacer can be located adjacent to one or more bearings in such vibrations in the bearing are absorbed directly by the spacer. Likewise, as illustrated in FIG. 5, the piezodynamic damping spacer can be coupled to the bearing through an intermediate member such that vibrations in the bearings are transferred through the intermediate member to the piezodynamic preload spacer.

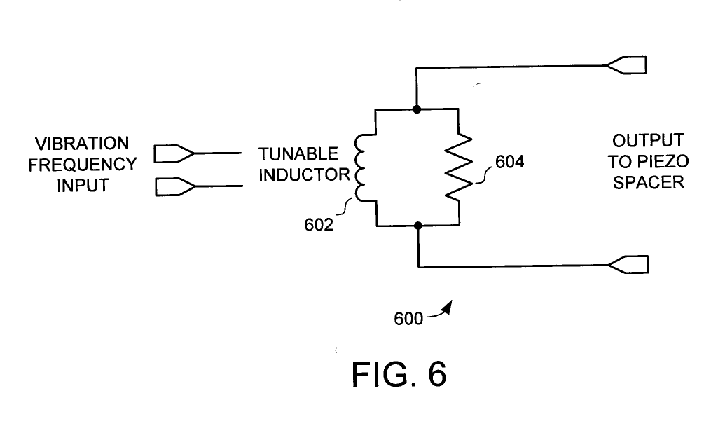

Turning now to FIG. 6, an exemplary tuning system 600 is illustrated schematically. This is just one example of the type of circuit that can be used as a turning system in the present invention. Again, the piezodynamic damping spacer converts the absorbed vibrations into electrical energy. The electrical energy created by the piezodynamic damping spacer is dissipated into the tuning system 600. The turning system 600 additionally provides the ability to tune the resonant frequency of the vibration damping device. Thus, the tuning system 600 provides the ability to optimize the absorption of disturbances in specific frequency ranges. The tuning system 600 preferably adjusts the resonant frequency of the vibration damping device to best absorb disturbances in selected problem frequency ranges.

The turning system 600 includes a vibration frequency input, a tunable inductor 602 and a resistor 604. The tuning system receives vibration frequency data from the vibration frequency input and selectively adjusts the tunable inductor 602 to adjust the resonant frequency of the vibration damping device. In this embodiment, the piezodynamic damping spacer has capacitance and thus the tuning system 600 acts as an RLC circuit that can be tuned by changing the inductance of the tunable inductor 602. Thus, by changing the inductance the resonant frequency of the RLC circuit can be optimized to absorb vibrations in a particular frequency range. The tunable inductor 602 is preferably implemented using operational amplifier configured as a tunable inductor. This allows for high inductance to be provided without the large size and weight of a normal inductor.

The vibration frequency input provides vibration frequency data to the tuning system 600. The vibration frequency input can receive vibration frequency data from a variety of sources. As one embodiment, the vibration frequency data can be generated based on the operational speed of the momentum control device. In this embodiment, sensor data indicating the operational speed is used to generate vibration frequency data.

Typically, momentum control devices create vibrations during operation. The frequencies of the vibrations created by a momentum control device are often related to the operational speed of the device. As examples, the operational speed of the momentum control device can be related to vibrations such as tachometer ripple, cogging, and other high frequency disturbances. The operational speed of the momentum control device can be used as a basis to estimate the frequencies of vibrations created by the momentum control device. Thus, given the operational speed of the device, the resulting vibration frequencies can be determined and used by the tuning circuit to tune the piezodynamic damping spacer to absorb the vibrations. As the operational speed changes, the tuning circuit can adjust the resonant frequency to track the changes in created vibrations. Thus, the piezodynamic damping spacer can effectively absorb frequencies created throughout the operational range of the momentum control device.

As one example, reaction wheel assemblies (RWA's) are typically utilized from approximately 0 RPM to +/−6000 RPM during normal spacecraft operations. At full speed (+/−6000 RPM) the primary disturbance frequencies occur at 100 Hz and its harmonics at 200 and 300 Hz. In addition a bearing sub-harmonic approximately at 38 Hz also occurs. The frequencies of these disturbances will drop linearly in value as the RWA speed changes. Thus, given knowledge of the RWA operational frequency from the speed data, the piezodynamic damping device can be tuned to absorb disturbances created by the RWA.

As another example, a control moment gyroscope (CMG) is typically operated a constant spin speed so the disturbance frequencies are usually fixed in value. In this application, the piezodynamic tuning circuit may only have to be adjusted when the CMG fixed spin speed is modified. In other configurations, CMG's can have a variable spin speed (over limited ranges) like an RWA and likewise create disturbances of various frequencies. Again, given knowledge of the CMG operational frequency from the speed data, the piezodynamic damping device can be tuned to absorb disturbances created by the CMG.

Typical momentum control devices include tachometers or other rotational speed measuring devices. Data from the tachometer can be used to provide speed data and thus provide the vibration frequency data to the tuning system. In other embodiments, different sensors can be used to measure the speed of momentum control device and generate the vibration frequency data. In any of these cases, the vibration frequency data can be then be used to adjust the resonant frequency of the vibration damping device.

As another embodiment, the vibration frequency data can be generated by one or more sensors designed to directly measure vibrations and determine their frequency. Such sensors can be any of those suitable to measure vibrations created by the momentum control device.

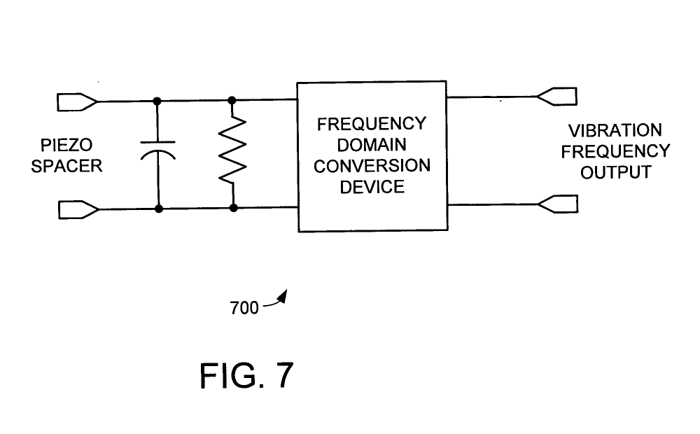

In one example of this embodiment, the piezodynamic damping spacer itself is used as a vibration frequency sensor for measuring disturbances on the device. Turning now to FIG. 7, an exemplary disturbance measuring system 700 is illustrated. The disturbance measuring system 700 is coupled to the piezodynamic damping spacer. Typically, this would involve connecting sensor leads to at least a portion of the piezodynamic preload spacer. Vibrations in the bearings are transferred to the piezodynamic damping spacer, and the piezodynamic damping spacer provides a voltage signal proportional to those vibrations. This signal is passed to a frequency domain conversion that converts the disturbance signal to a frequency domain signal that can be used as the vibration frequency data. Thus, the piezodynamic damping spacer itself is used to directly measure vibration in the bearings, and thus is used to provide vibration frequency data that is used to adjust the resonant frequency of the vibration damping device. In addition, this data can be used to create a bearing signature profile which can be compared to previous ground test or life test data that can be used to trouble shoot problems in-orbit and extend mission life of the unit.

The present invention thus provides a vibration damping device and method for momentum control devices. The vibration damping device includes a piezodynamic damping spacer and a tuning system. The piezodynamic damping spacer is coupled to a bearing in the momentum control device. The piezodynamic damping spacer is configured such that vibrations in the momentum control device are absorbed by piezodynamic damping spacer. The piezodynamic damping spacer converts these vibrations to electrical energy, where they can be dissipated by the tuning system. The tuning system provides the ability to tune the vibration damping device to most effectively absorb vibrations in specific frequency ranges. Thus, the vibration damping device is able to effectively reduce vibrations in the momentum control device.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A vibration damping device, the vibration damping device comprising:
a) a piezodynamic damping spacer, the piezodynamic damping spacer coupled to a bearing in a momentum control device, the piezodynamic damping spacer configured such vibrations in the bearing are absorbed by the piezodynamic damping spacer and converted to electrical energy; and
b) a tuning system electrically coupled to the piezodynamic damping spacer, the tuning system providing selective control of a resonant frequency of the vibration damping device such that the vibration damping device absorbs vibrations in a selected frequency range.

2. The vibration damping device of claim 1 wherein the piezodynamic damping spacer is located adjacent the bearing.

3. The vibration damping device of claim 1 wherein the bearing comprises a duplex bearing pair and wherein piezodynamic damping spacer is located between the duplex bearing pair.

4. The vibration damping device of claim 1 wherein the piezodynamic damping spacer comprises a ring shaped spacer having a thickness.

5. The vibration damping device of claim 1 wherein the piezodynamic damping spacer comprises a piezoelectric material.

6. The vibration damping device of claim 1 wherein the piezodynamic damping spacer is coupled to the bearing through an intermediate member.

7. The vibration damping device of claim 1 wherein the momentum control device comprises a reaction wheel.

8. The vibration damping device of claim 1 wherein the momentum control device comprises a control moment gyroscope.

9. The vibration damping device of claim 1 wherein the tuning system includes an operational amplifier to implement a tunable inductor to provide the selective control of the resonant frequency.

10. The vibration damping device of claim 1 wherein the tuning system includes an input to receive sensor data indicating an operational speed of the momentum control device.

11. The vibration damping device of claim 10 wherein the tuning system adjusts the resonant frequency in response to the sensor data.

12. The vibration damping device of claim 1 further comprising a vibration sensor circuit, the vibration sensor circuit electrically coupled to the piezodynamic damping spacer to measure vibrations in the bearing.

13. The vibration damping device of claim 12 wherein the vibration sensor circuit provides a vibration frequency output to tuning circuit, the vibration frequency output proportional to a frequency of the measured vibrations in the bearing.

14. A vibration damping device for reducing vibrations in a momentum control device, the vibration damping device comprising:
a) a piezodynamic damping spacer, the piezodynamic damping spacer coupled to a bearing in the momentum control device, the piezodynamic damping spacer configured such that vibrations in the bearing are absorbed by the piezodynamic damping spacer and converted to electrical energy;
b) a sensor circuit, the sensor circuit electrically coupled to at least a portion of the piezodynamic damping spacer to measure the vibrations absorbed by the piezodynamic damping spacer, the sensor circuit providing a vibration frequency output proportional to a measured frequency of the vibrations; and
c) a tuning system electrically coupled to the piezodynamic damping spacer, the tuning system receiving the sensor output and providing selective control of a resonant frequency of the vibration damping device, the tuning system adjusting the resonant frequency of the vibration damping device such that the vibration damping device efficiently absorbs vibrations in the measured frequency of the vibrations.

15. The vibration damping device of claim 14 wherein piezodynamic damping spacer comprises a ring shaped spacer having a thickness, and wherein piezodynamic damping spacer absorbs the vibrations by changes in the thickness.

16. The vibration damping device of claim 14 wherein the piezodynamic damping spacer is coupled to the bearing through an intermediate member.

17. The vibration damping device of claim 14 wherein the tuning system includes an operational amplifier to implement a tunable inductor to provide the selective control of the resonant frequency.

18. A vibration damping device for reducing vibrations in a momentum control device, the vibration damping device comprising:
a) a piezodynamic damping spacer, the piezodynamic damping spacer coupled to a bearing in the momentum control device, the piezodynamic damping spacer configured such that vibrations in the bearing are absorbed by the piezodynamic damping spacer and converted to electrical energy;
b) a sensor input to receive sensor data indicating an operational speed of the momentum control device; and
c) a tuning system electrically coupled to the piezodynamic damping spacer, the tuning system receiving the sensor data and providing selective control of a resonant frequency of the vibration damping device in response to the sensor data, the tuning system adjusting the resonant frequency of the vibration damping device such that the vibration damping device efficiently absorbs vibrations created by the momentum control device at the operational speed.

19. The vibration damping device of claim 18 wherein piezodynamic damping spacer comprises a ring shaped spacer having a thickness, and wherein piezodynamic damping spacer absorbs the vibrations by changes in the thickness.

20. The vibration damping device of claim 18 wherein the piezodynamic damping spacer is coupled to the bearing through an intermediate member.

21. The vibration damping device of claim 18 wherein the tuning system includes an operational amplifier to implement a tunable inductor to provide the selective control of the resonant frequency.
